(19) United States
(12) Patent Application Publication
(10) Pub. No.: US 2019/0137960 A1
(43) Pub. Date: May 9, 2019

(54) CALCULATING METHOD OF CONFIGURATION COST OF POWER SYSTEM

(71) Applicant: M-FIELD ENERGY LTD., HSINCHU COUNTY (TW)

(72) Inventor: FU-CHENG WANG, HSINCHU COUNTY (TW)

(21) Appl. No.: 15/835,885

(22) Filed: Dec. 8, 2017

(30) Foreign Application Priority Data
Nov. 3, 2017 (TW) 106138127

(51) Int. Cl. G05B 17/02; G06Q 50/06; H02J 9/00; G06F 17/12; H02J 9/06; H02J 4/00

(52) U.S. Cl. CPC G05B 17/02; G06Q 50/06; H02J 4/00; G06F 17/12; H02J 9/066; H02J 9/002

(57) ABSTRACT

A calculating method of configuration cost of a power system adjusts an amount parameter of an electricity storage device and an amount parameter of a first power generation device according to an adjustment procedure to calculate a plurality of cost parameters, and records the cost parameters. The calculating method further selects the smallest cost parameter from the recorded cost parameters, and displays the smallest cost parameter, the amount parameter of the electricity storage device corresponding to the smallest cost parameter, and the amount parameter of the first power generation device corresponding to the smallest cost parameter. Therefore, the user determines the smallest cost parameter, and the amount parameters corresponding to the smallest cost parameter to increase the user's willingness to build the power system.

### CROSS-REFERENCE TO RELATED APPLICATIONS

This application claims the priority benefit of TW application serial No. 106138127, filed on Nov. 3, 2017. The entirety of the above-mentioned patent application is hereby incorporated by reference herein and made a part of the specification.

### BACKGROUND OF THE INVENTION

### 1. Field of the Invention

The present invention relates to a calculating method, and more particularly to a calculating method of configuration cost of a power system.

### 2. Description of the Related Art

With the development of technology, more and more equipment and devices are powered by electricity. Electricity power is mostly provided by an electricity company. The electricity company may build power plants to generate and provide the electricity power to users. The electricity company may charge a payable fee according to an amount of electricity power consumed by the users.

However, the electricity company may not limit how the users consume the electricity power. Therefore, when a total amount of electricity consumption by all of the users approaches or exceeds the greatest load that the electricity company can afford, the electricity company may not provide adequate electricity power to the users. Then, the electricity company may stop providing the electricity power or implement electricity rationing. No matter stopping providing or rationing the electricity power, the users can not use the electricity power conveniently.

Therefore, some of the users may build power plants themselves, and thereby the users may not worry about that whether the electricity company can afford the total amount of the electricity consumption, or that whether the electricity company stops providing the electricity power or implement electricity rationing the electricity power. The users may use stably the electricity power generated by the power plants built by themselves. Further, when the users build power plants themselves, the load that the electricity company should afford may be decreased to avoid that the electricity company has to stop providing the electricity power or implement rationing of the electricity power.

However, the cost to build the power plant is high. Normally, a supplier of the power plants provides design and cost estimate of power generation equipment. Namely, the amount of the power plants is decided by the suppliers according to their experience. The design of the power plants may not fit with demands for electricity of the users, and the cost for building the power generation equipment may be increased. Then, the user's willingness to build the power plants may be decreased.

### SUMMARY OF THE INVENTION

An objective of the present invention is to provide a calculating method of configuration cost of a power system. The calculating method may provide a suitable configuration of a power system to decrease configuration cost of the power system.

To achieve the foregoing objective, the calculating method of the present invention comprises the steps of:

a. receiving a configuration cost parameter of an electricity storage device and an operation cost parameter of the electricity storage device;

b. receiving a configuration cost parameter of a first power generation device and an operation cost parameter of the first power generation device;

c. respectively setting an amount parameter of the electricity storage device and an amount parameter of the first power generation device as initial values;

d. calculating and recording a cost parameter according to the configuration cost parameter of the electricity storage device, the operation cost parameter of the electricity storage device, the configuration cost parameter of the first power generation device, the operation cost parameter of the first power generation device, the amount parameter of the electricity storage device, and the amount parameter of the first power generation device;

e. determining whether the amount parameter of the electricity storage device exceeds a first upper limit threshold value;

f. when the amount parameter of the electricity storage device exceeds the first upper limit threshold value, determining whether the amount parameter of the first power generation device exceeds a second upper limit threshold value;

g. when the amount parameter of the first power generation device exceeds the second upper limit threshold value, selecting the smallest cost parameter from the cost parameters that have been recorded, and displaying the smallest cost parameter, the amount parameter of the electricity storage device corresponding to the smallest cost parameter, and the amount parameter of the first power generation device corresponding to the smallest cost parameter;

h. when the amount parameter of the electricity storage device exceeds the first upper limit threshold value or when the amount parameter of the first power generation device does not exceed the second upper limit threshold value, adjusting the amount parameter of the electricity storage device and the amount parameter of the first power generation device according to an adjustment procedure, and executing the step d.

The present invention adjusts the amount parameter of the electricity storage device and the amount parameter of the first power generation device to calculate the cost parameters in different parameter conditions. The present invention further displays the smallest cost parameter, the amount parameter of the electricity storage device corresponding to the smallest cost parameter, and the amount parameter of the first power generation device corresponding to the smallest cost parameter. Therefore, the user may determine the smallest cost parameter, and the amount parameter of the electricity storage device and the amount parameter of the electricity storage device corresponding to the smallest cost parameter.

Further, since space for mounting the electricity storage device and the first power generation device may limit the amount of the electricity storage device and the amount of the first power generation device, the user may preset the first upper limit threshold value and the second upper limit threshold value to limit the amount parameter of the electricity storage device and the amount parameter of the first power generation device. Therefore, the user may determine the smallest cost for building the power system, and the user's willingness to build the power system may be increased.

Other objectives, advantages and novel features of the invention will become more apparent from the following detailed description when taken in conjunction with the accompanying drawings.

### BRIEF DESCRIPTION OF THE DRAWINGS

FIGS. 1 and 2 are flowcharts of an embodiment of a calculating method of configuration cost of a power system of the present invention;

FIG. 3 is a flowchart of an adjustment procedure of the calculating method of configuration cost of the power system of the present invention; and

FIG. 4 is a flowchart of another embodiment of the calculating method of configuration cost of the power system of the present invention.

### DETAILED DESCRIPTION OF THE INVENTION

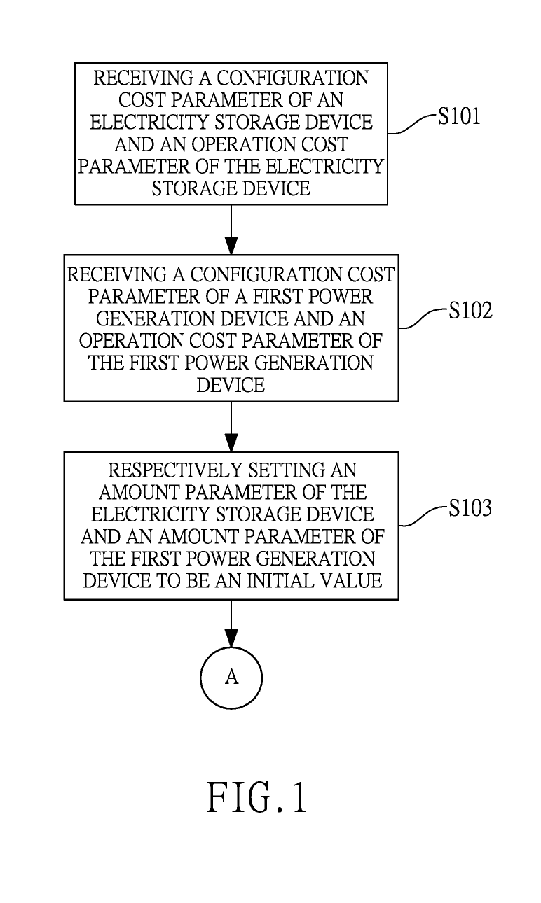

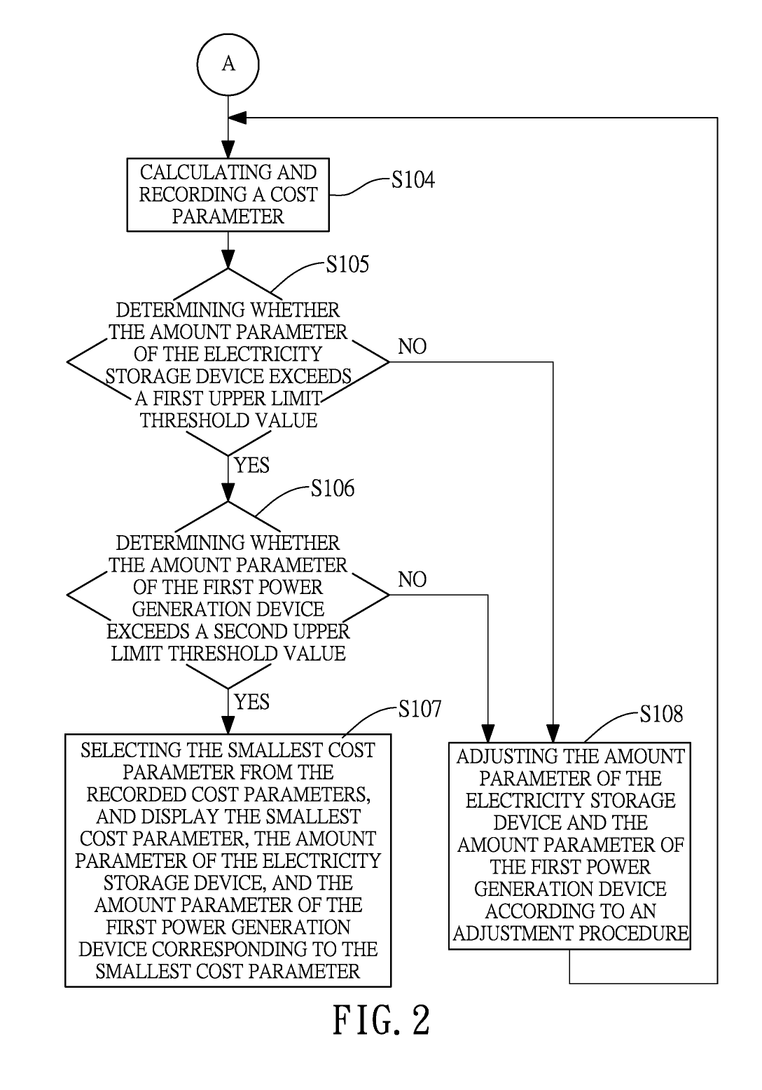

With reference to FIGS. 1 and 2, the present invention is a calculating method of configuration cost of a power system of the present invention. The calculating method may be executed by a computer or a server. The calculating method including the steps of:

receiving a configuration cost parameter of an electricity storage device and an operation cost parameter of the electricity storage device (S101);

receiving a configuration cost parameter of a first power generation device and an operation cost parameter of the first power generation device (S102);

respectively setting an amount parameter of the electricity storage device and an amount parameter of the first power generation device as initial values (S103);

calculating and recording a cost parameter according to the configuration cost parameter of the electricity storage device, the operation cost parameter of the electricity storage device, the configuration cost parameter of the first power generation device, the operation cost parameter of the first power generation device, the amount parameter of the electricity storage device, and the amount parameter of the first power generation device (S104);

determining whether the amount parameter of the electricity storage device exceeds a first upper limit threshold value (S105);

when the amount parameter of the electricity storage device exceeds the first upper limit threshold value, determining whether the amount parameter of the first power generation device exceeds a second upper limit threshold value (S106);

when the amount parameter of the first power generation device exceeds the second upper limit threshold value, selecting the smallest cost parameter from the cost parameters that have been recorded, and displaying the smallest cost parameter, the amount parameter of the electricity storage device corresponding to the smallest cost parameter, and the amount parameter of the first power generation device corresponding to the smallest cost parameter (S107);

when the amount parameter of the electricity storage device does not exceed the first upper limit threshold value or when the amount parameter of the first power generation device does not exceed the second upper limit threshold value, adjusting the amount parameter of the electricity storage device and the amount parameter of the first power generation device according to an adjustment procedure (S108), and executing the step S104.

Each time when the amount parameter of the electricity storage device and the amount parameter of the first power generation device are adjusted according to the adjustment procedure, one cost parameter is calculated and recorded. Therefore, when the amount parameter of the first power generation device exceeds the second upper limit threshold value, there is a plurality of calculated and recorded cost parameters.

The present invention adjusts the amount parameter of the electricity storage device and the amount parameter of the first power generation device to calculate the cost parameters in different parameter conditions. The present invention further displays the smallest cost parameter, the amount parameter of the first power generation device corresponding to the smallest cost parameter, and the amount parameter of the electricity storage device corresponding to the smallest cost parameter. Therefore, the user may determine the smallest cost parameter, and the amount parameter of the electricity storage device and the amount parameter of the electricity storage device corresponding to the smallest cost parameter. Hence, the cost for building the power system may be decreased to improve the user's willingness to build the power system.

Further, since space for mounting the electricity storage device and the first power generation device may limit the amount of the electricity storage device and the amount of the first power generation device, the user may preset the first upper limit threshold value and the second upper limit threshold value to limit the amount parameter of the electricity storage device and the amount parameter of the first power generation device. Therefore, the user may determine the smallest cost for building the power system, and the user's willingness to build the power system may be increased.

The cost parameter is calculated by the following formula:

J=(J0ᵢ+J0₀)×n0+(J1ᵢ+J1₀)×n1;

J is the cost parameter, J0ᵢ is the configuration cost parameter of the electricity storage device, J0₀ is the operation cost parameter of the electricity storage device, n0 is the amount parameter of the electricity storage device, J1₀ is the configuration cost parameter of the first power generation device, J1₀ is the operation cost parameter of the first power generation device, and n1 is the amount parameter of the first power generation device.

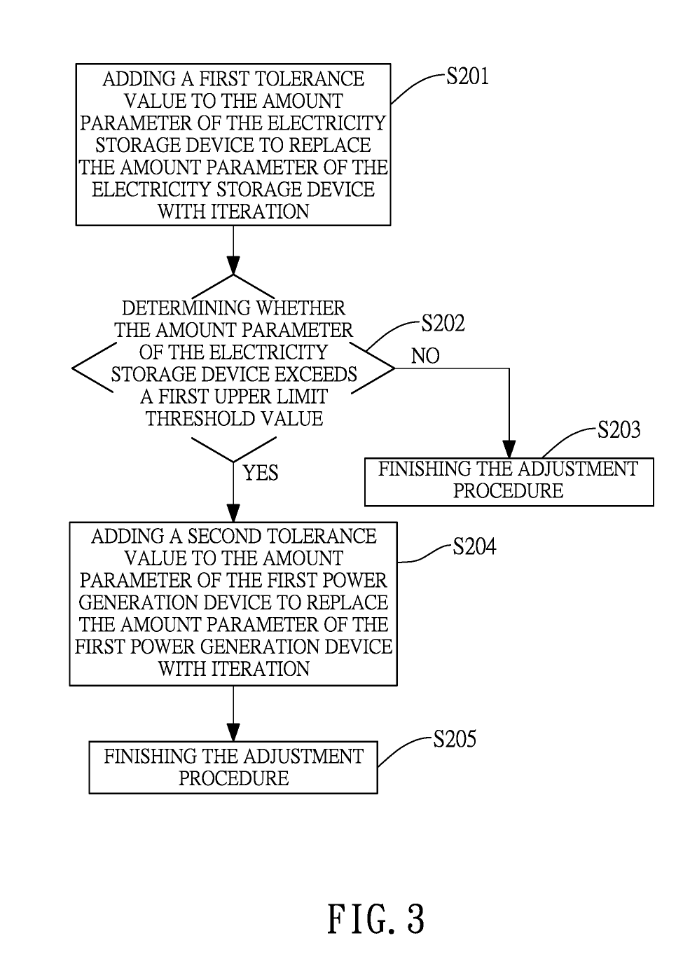

With reference to FIG. 3, the adjustment procedure includes the steps of:

adding a first tolerance value to the amount parameter of the electricity storage device to replace the amount parameter of the electricity storage device with iteration (S201);

determining whether the amount parameter of the electricity storage device exceeds the first upper limit threshold value (S202);

when the amount parameter of the electricity storage device does not exceed the first upper limit threshold value, finishing the adjustment procedure (S203);

when the amount parameter of the electricity storage device exceeds the first upper limit threshold value, adding a second tolerance value to the amount parameter of the first power generation device to replace the amount parameter of the first power generation device with iteration (S204), and finishing the adjustment procedure (S205).

The amount parameter of the electricity storage device and the amount parameter of the first power generation device may be adjusted by the adjustment procedure. In the adjustment procedure, the first tolerance value and the second tolerance value are adjustment intervals of the amount parameter of the electricity storage device and the amount parameter of the first power generation device. Therefore, the amount parameter of the electricity storage device and the amount parameter of the first power generation device may be adjusted step by step, and the cost parameter may be calculated step by step to completely analyze the cost parameters in different parameter conditions. The selected cost parameter is the smallest value in preset parameter conditions.

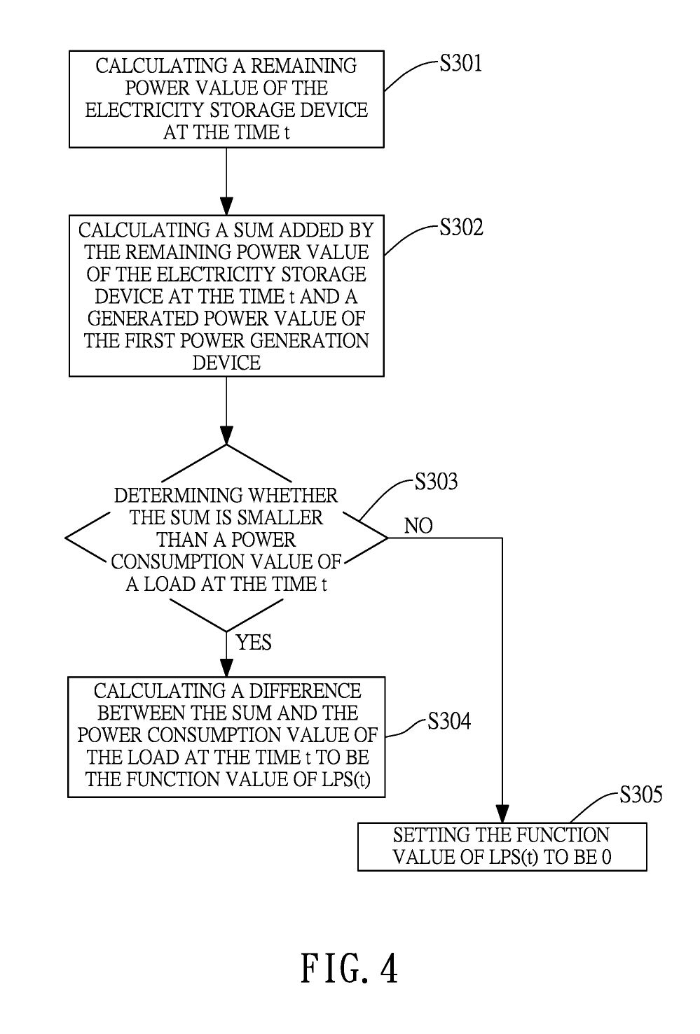

With reference to FIG. 4, after the step S107 is executed, the calculating method further includes the steps of:

calculating a safety parameter; wherein the safety parameter is calculated by the following formula:

$$LPSP = \frac{{\sum }_{t = 1}^{T} LPS ( t )}{{\sum }_{t = 1}^{T} {E}_{load} ( t )} ;$$

wherein LPSP is the safety parameter, E_{load}(t) is a function of a power consumption of a load over a time interval, T is the time interval, t is a time parameter;

wherein LPS(t) is calculated by the step of:
calculating a remaining power value of the electricity storage device at the time t (S301);
calculating a sum added by the remaining power value of the electricity storage device at the time t and a generated power value of the first power generation device (S302);
determining whether the sum is smaller than a power consumption value of a load at the time t (S303);
when the sum is smaller than the power consumption value of the load at the time t, calculating a difference between the sum and the power consumption value of the load at the time t to be the function value of LPS(t) (S304);
when the sum is not smaller than the power consumption value of the load at the time t, setting the function value of LPS(t) to be 0 (S305).

For example, an operation time interval T of a power system is 6 hours, and the power consumption value of the load during the operation time interval T is 7 KWh. The sum added by the remaining power value of the electricity storage device and a generated power value of the first power generation device during the operation time interval T is 6.5 KWh.

LPSP is calculated by the following formula:

$$LPSP = \frac{{\sum }_{t = 1}^{T} LPS ( t )}{{\sum }_{t = 1}^{T} {E}_{load} ( t )} = \frac{7 - 65}{7} = 0.0714$$

Therefore, the power system has rate of 7.14% to shut down.

Namely, the present invention may further calculate the safety parameter to determine a rate to shut down the power system. The user may further consider whether the power system needs to be adjusted to improve the rate to shut down the power system.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A calculating method of configuration cost of a power system, comprising the steps of:
a. receiving a configuration cost parameter of an electricity storage device and an operation cost parameter of the electricity storage device;
b. receiving a configuration cost parameter of a first power generation device and an operation cost parameter of the first power generation device;
c. respectively setting an amount parameter of the electricity storage device and an amount parameter of the first power generation device as initial values;
d. calculating and recording a cost parameter according to the configuration cost parameter of the electricity storage device, the operation cost parameter of the electricity storage device, the configuration cost parameter of the first power generation device, the operation cost parameter of the first power generation device, the amount parameter of the electricity storage device, and the amount parameter of the first power generation device;
e. determining whether the amount parameter of the electricity storage device exceeds a first upper limit threshold value;
f. when the amount parameter of the electricity storage device exceeds the first upper limit threshold value, determining whether the amount parameter of the first power generation device exceeds a second upper limit threshold value;
g. when the amount parameter of the first power generation device exceeds the second upper limit threshold value, selecting the smallest cost parameter from the cost parameters that have been recorded, and displaying the smallest cost parameter, the amount parameter of the first power generation device corresponding to the smallest cost parameter, and the amount parameter of the electricity storage device corresponding to the smallest cost parameter;
h. when the amount parameter of the electricity storage device exceeds the first upper limit threshold value or when the amount parameter of the first power generation device does not exceed the second upper limit threshold value, adjusting the amount parameter of the electricity storage device and the amount parameter of the first power generation device according to an adjustment procedure, and executing the step d.

2. The calculating method of the configuration cost of the power system as claimed in claim 1, wherein the cost parameter is calculated by the following formula:
J=(J0ᵢ+J0₀)×n0+(J1ᵢ+J1₀)×n1;
wherein J is the cost parameter, J0ᵢ is the configuration cost parameter of the electricity storage device, J0₀ is the operation cost parameter of the electricity storage device, n0 is the amount parameter of the electricity storage device, J1ᵢ is the configuration cost parameter of the first power generation device, J1₀ is the operation cost parameter of the first power generation device, and n1 is the amount parameter of the first power generation device.

3. The calculating method of the configuration cost of the power system as claimed in claim 1, wherein the adjustment procedure includes the steps of:
adding a first tolerance value to the amount parameter of the electricity storage device to replace the amount parameter of the electricity storage device with iteration;
determining whether the amount parameter of the electricity storage device exceeds the first upper limit threshold value;
when the amount parameter of the electricity storage device does not exceed the first upper limit threshold value, finishing the adjustment procedure;
when the amount parameter of the electricity storage device exceeds the first upper limit threshold value, adding a second tolerance value to the amount parameter of the first power generation device to replace the amount parameter of the first power generation device with iteration, and finishing the adjustment procedure.

4. The calculating method of the configuration cost of the power system as claimed in claim 2, wherein the adjustment procedure includes the steps of:
adding a first tolerance value to the amount parameter of the electricity storage device to replace the amount parameter of the electricity storage device with iteration;
determining whether the amount parameter of the electricity storage device exceeds the first upper limit threshold value;
when the amount parameter of the electricity storage device does not exceed the first upper limit threshold value, finishing the adjustment procedure;
when the amount parameter of the electricity storage device exceeds the first upper limit threshold value, adding a second tolerance value to the amount parameter of the first power generation device to replace the amount parameter of the first power generation device with iteration, and finishing the adjustment procedure.

5. The calculating method of the configuration cost of the power system as claimed in claim 1, wherein when the step h is executed, the calculating method further include the steps of:
calculating a safety parameter; wherein the safety parameter is calculated by the following formula:
$$LPSP = \frac{{\sum }_{t = 1}^{T} LPS ( t )}{{\sum }_{t = 1}^{T} {E}_{load} ( t )} ;$$
wherein LPSP is the safety parameter, E_{load}(t) is a function of a power consumption of a load over a time interval, T is the time interval, and t is a time parameter;
wherein LPS(t) is calculated by the step of:
calculating a remaining power value of the electricity storage device at the time t;
calculating a sum added by the remaining power value of the electricity storage device at the time t and a generated power value of the first power generation device;
determining whether the sum is smaller than a power consumption value of a load at the time t;
when the sum is smaller than the power consumption value of the load at the time t, calculating a difference between the sum and the power consumption value of the load at the time t to be the function value of LPS(t).
when the sum is not smaller than the power consumption value of the load at the time t, setting the function value of LPS(t) to be 0.
